(19) United States
(12) Patent Application Publication
(10) Pub. No.: US 2012/0056051 A1
(43) Pub. Date: Mar. 8, 2012

(54) FASTENER ASSEMBLY

(76) Inventor: Peter Gold, Rockville Centre, NY (US)

(21) Appl. No.: 13/163,829

(22) Filed: Jun. 20, 2011

Related U.S. Application Data
(60) Provisional application No. 61/379,778, filed on Sep. 3, 2010.

(51) Int. Cl. F16M 13/02; F16B 35/00; B23P 11/00; F16B 15/00

(52) U.S. Cl. 248/222.14; 248/220.21; 248/224.8; 29/525.01

(57) ABSTRACT

A fastener assembly for mounting an object on a wall, according to the invention, includes a substantially planar member having at least one ledge extending substantially perpendicular therefrom, the member being configured to permit at least a portion of the planar member to lie flush against the wall, with the ledge inserted at least partially through the wall. The fastener assembly serves uniquely as a support or crutch in order to increase the previously unused load carrying abilities of both the fastener and wall to support heavier objects.

### CROSS-REFERENCE TO RELATED APPLICATIONS

This application claims benefits from U.S. Provisional Patent Application No. 61/379,778, filed Sep. 3, 2010, the contents of which are hereby incorporated herein by reference.

### BACKGROUND OF THE INVENTION

1. Field of the Invention

This invention relates broadly to fasteners. More particularly, this invention relates to fastener assemblies for hanging objects on wall board.

2. State of the Art

As described in published Patent Application No. 2007/0235622, the contents of which are hereby incorporated by reference, gypsum wallboard, also known as drywall, SHEETROCK®, plasterboard, gib board, rock lath, and gypsum board became popular for home construction following World War II and have for the most part replaced plaster walls previously common in residential and commercial construction. The wallboard is comprised of a pair of sheathings or liners on both sides of a gypsum based core. The liner material can be paper, polymers, or other sheet materials. Gypsum wallboard, in the United States, is available in thicknesses of ¼ inch, ⅜ inch, ½ inch, ⅝ inch, ¾ inch and 1 inch with ½ inch being the most commonly used.

For gypsum core wallboard, it is known that when anchoring objects force distribution between the anchor and the wallboard is critical as gypsum core will crush easily under concentrated localized shear forces. Conventional attachment means, such as a nail, are not effective in drywall except for holding very modest weights due to the concentration of force. Weight from an object suspended on the nail tends to crush the gypsum and rip the paper immediately below the nail. Any such displacement by the nail loosens and weakens the attachment. The moment caused by the weight about the generalized pivot region of the nail generally provides a dislodgement force component of the nail that is increased as the nail is loosened and approaches and extends below horizontal. Such nails that are solely in gypsum wallboard are clearly not usable for attaching appurtenances such as shelves, bathroom accessories, or any object that will be manipulated on the wall.

More substantial attachment to conventional gypsum wallboard is accomplished by connectors that utilize clamping members that pierce the wallboard and provide a clamping action, typically by way of a screw, between the inner and outer surfaces of the gypsum wallboard. Such hangers provide very secure attachment but are relatively complicated, usually with two or more moving parts and can be tedious to install. Also, where there is a stud or no cavity behind the wallboard, such connectors won't work. Moreover, these connectors cause significant damage to the wall when removed and may be very difficult to remove. Other gypsum wallboard connectors utilize an expanding cylinder or conical insert that provides significantly more surface area contact with the wallboard. These also utilize a plurality of components, and take several distinct operations to install. If removed, there is significant damage to the wallboard.

Therefore, it is advantageous to have a fastening assembly which is relatively simple to use and manufacture and which can be utilized in conjunction with a variety of fastening devices such as nails, screws, expandable hollow wall fasteners, molly fasteners, etc., in order to increase the load carrying capabilities of such fasteners. It is also advantageous to have a fastening assembly which is simple, quick and easy to use and install.

The prior art discloses many-different types of fastening devices or assemblies for mounting objects on sheet rock walls and the like. However, so far as is known, none of the prior art devices resolve all of these problems in a simple, effective and yet highly advantageous manner as in the present invention discussed herein.

### SUMMARY OF THE INVENTION

It is therefore an object of the invention to provide a novel fastening assembly for retaining an object to a wall.

It is also an object of the invention to provide a fastening assembly which significantly increases the load carrying capabilities of a fastener.

It is another object of the invention to provide a universally adaptable fastening assembly for use with various fasteners.

It is a further object of the invention to provide a fastening assembly which is easy to remove.

It is yet another object of the invention to provide a fastening assembly which minimizes damage to the wall when removed.

It is yet another object of the invention to provide a fastening assembly which has a relatively simple construction and is quick and easy to use and install.

It is yet another object of the invention to provide a fastening assembly which is simple, easy and inexpensive to manufacture.

Certain of the foregoing and related objects are readily attained according to the present invention by the provision of a fastener assembly for mounting an object on a wall, comprising a substantially planar member having at least one ledge extending substantially perpendicular therefrom, said member being configured to permit at least a portion of said planar member to lie flush against the wall with said at least one ledge inserted at least partially through the wall and means for fastening said member to the wall.

Advantageously, said at least one ledge has a length which is less than a thickness of the wall. Alternatively, said at least one ledge has a length which is equal to or greater than the thickness of the wall. In a preferred embodiment, said member has a through-bore. Preferably, said through-bore has an axis which forms an acute angle relative to said member. Alternatively, said through-bore has an axis which is substantially perpendicular to said member. Desirably, said means for fastening said member to the wall comprises a nail which is receivable within said through-bore. In the alternative, said means for fastening said member to the wall comprises a molly fastener and a screw receivable within said through-bore.

Furthermore, it is also desirable that said means for fastening said member to the wall comprises an adhesive layer disposed on said back side of said member. Alternatively, said member has a front side and a back side and said means for fastening comprises a curved, support member having a tip projecting outwardly and rearwardly from the back side of said member which, when fully mounted, projects through the wall with its tip resiliently contacting a concealed surface of the wall. Preferably, said member defines a bottom edge and said at least one ledge is located on said bottom edge of said member. In another embodiment, said member defines a top edge and said at least one ledge is located on said top edge of said member. Alternatively, said member defines a top edge and a bottom edge and said at least one ledge is disposed between said top and bottom edges.

It is also desirable that the fastener assembly further comprise means for supporting the object on the wall. In another embodiment, said planar member has means for supporting the object on the wall. In a further embodiment, said means for fastening also serves to support the object on the wall.

Certain of the foregoing and related objects of the invention are also readily attained by the provision of a method of installing a fastener assembly for mounting an object on a wall comprising the steps of providing a fastener assembly comprising a substantially planar member having at least one ledge extending substantially perpendicular therefrom, said member being configured to permit at least a portion of said planar member to lie flush against the wall with said at least one ledge inserted at least partially through the wall and means for fastening said member to the wall inserting said at least one ledge at least partially into the wall so that at least a portion of said member lies flush against the wall; and securing said member to the wall via said means for fastening.

Preferably, said at least one ledge has an edge to permit it to pierce the wall during said inserting step. Most desirably, said fastening assembly further comprises means for supporting the object. Advantageously, the method further comprises the step of securing the object to said means for supporting the object.

The preferred embodiments of the present invention will now be more particularly described by way of example with reference to the accompanying drawings.

### BRIEF DESCRIPTION OF THE DRAWINGS

Other objects and features of the present invention will become apparent from the detailed description considered in connection with the accompanying drawings, which disclose several embodiments of the invention. It is to be understood that the drawings are to be used for the purpose of illustration only and not as a definition of the limits of the invention.

FIG. 1 is a side elevational view, partially in section, illustrating a first embodiment of the invention mounted on a wall in conjunction with a nail;

FIG. 2 is a perspective view of the first embodiment;

FIG. 3 is a side elevational view, partially in section, illustrating a second embodiment of the invention mounted on a wall in conjunction with a molly fastener and a hook;

FIG. 4 is a perspective view of the second embodiment;

FIG. 5A is a perspective view of a third embodiment of the invention;

FIG. 5B is a side elevational view, partially in section, illustrating the third embodiment mounted on a wall;

FIG. 6A is a perspective view of a fourth embodiment;

FIG. 6B is a side elevational view, partially in section, illustrating the fourth embodiment mounted on a wall;

FIG. 7A is a perspective view of a fifth embodiment;

FIG. 7B is a side elevational view, partially in section, illustrating the fifth embodiment mounted on a wall;

FIG. 8A is a perspective view of a sixth embodiment;

FIG. 8B is a side elevational view, partially in section, illustrating the sixth embodiment mounted on a wall;

FIG. 9A is a perspective view of a seventh embodiment;

FIG. 9B is a side elevational view, partially in section, illustrating the seventh embodiment mounted on a wall;

FIG. 10A is a perspective view of a eighth embodiment;

FIG. 10B is a side elevational view, partially in section, illustrating the eighth embodiment of the invention mounted on a wall in conjunction with a decorative hook;

FIG. 10C is a perspective view of the decorative hook;

FIG. 11A is a perspective view of a ninth embodiment; and

FIG. 11B is a side elevational view, partially in section, illustrating the ninth embodiment of the invention mounted on a wall.

### DETAILED DESCRIPTION OF THE PREFERRED EMBODIMENTS

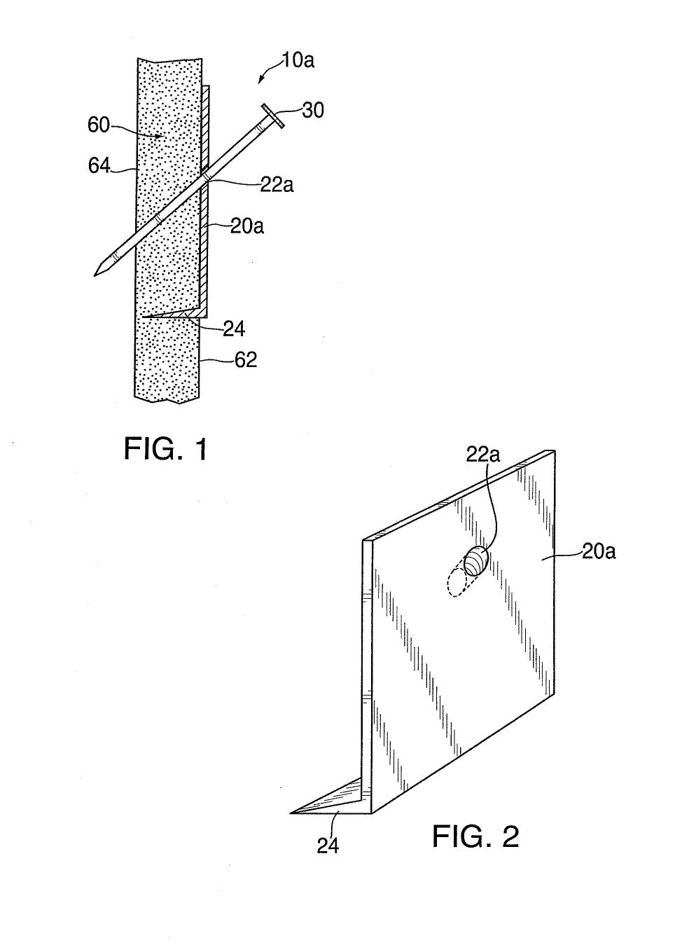

Turning now to FIG. 1, a fastening assembly 10a according to a first embodiment of the invention is shown in conjunction with a nail 30 mounted on a wall 60 (e.g., gypsum wall board), shown in cross-section. The fastener assembly 10a, shown without the nail 30 in FIG. 2, includes a generally L-shaped support comprising a plate 20a (planar portion) defining a through-bore 22a and having a lower ledge 24. Preferably, the plate 20a is made of a metal material, however, it can be appreciated that other suitable materials can be utilized. Moreover, although the fastening assembly is shown mounted on a wall of gypsum wallboard, it can be utilized with walls of other materials or to secure an object to something other than a wall.

The lower ledge 24 may be sharp, or having a tapered or pointed end as illustrated, to facilitate penetration of the wall 60. Alternatively, the ledge 24 may be blunt and the wall 60 scored before installation. According to this embodiment, the through-bore 22a is angled (e.g. forms an acute angle relative to the plate) so that the nail 30 enters the wall 60 at an angle and the head of the nail acts as the “hook” to support an object (not shown). As illustrated, the ledge 24 is substantially perpendicular to the plate 20a and is dimensioned so that it extends at least partially into the wall 60 but does not puncture the inside face 64 of the wall. The ledge 24 also includes a flat bottom edge and an angled top edge. It is preferable that the ledge extend ¾ of the width of the wall, however, it can be dimensioned so that it is inserted to other depths. The ledge 24 may be manually pressed into the wall 60 or with the aid of a hammer.

When installed, the plate 20a lies flush against the exposed surface 62 of the wall 60 with the ledge 24 extending into the wall 60. The plate 20a serves as a crutch, support or means to spread out the load on the wall 60 and, thereby, increasing the load carrying abilities of the nail 30, so that the nail 30 can support heavier objects than it could without plate 20a.

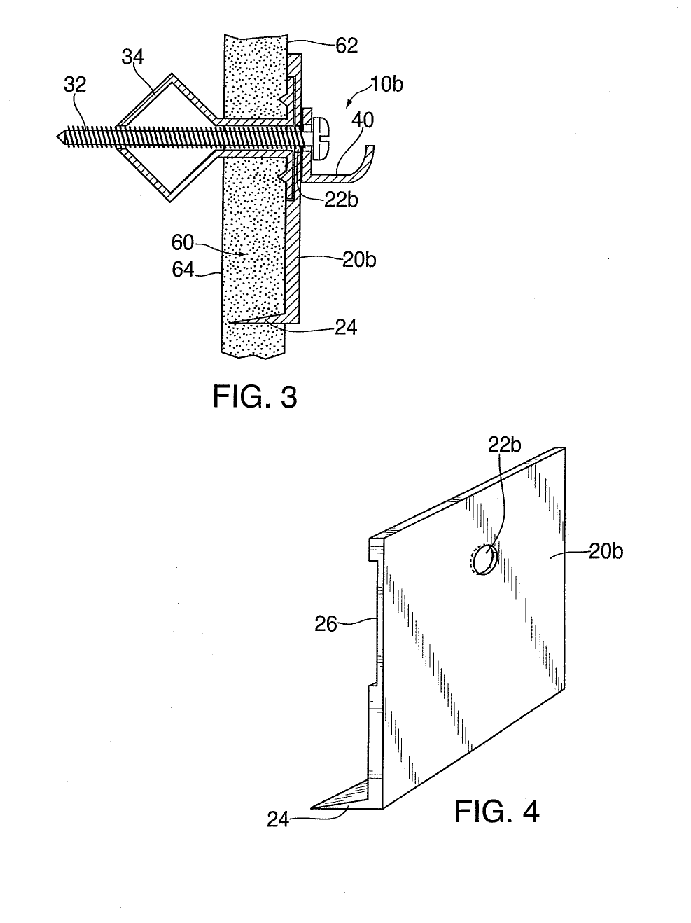

Referring now to FIGS. 3 and 4, a second embodiment of the invention is illustrated. As shown in FIG. 3, a fastening assembly 10b according to the second embodiment includes a molly fastener 34, screw 32 and a hook 40, however, it can be appreciated that other fasteners can be utilized. As seen best in FIG. 4, the second embodiment of the fastener assembly 10b includes a plate 20b defining a through-bore 22b and having a lower ledge 24. In this embodiment, the through-bore 22b is a straight through-bore (e.g. having an axis substantially perpendicular to the plate), not angled. In addition, a recess 26 is provided on the side of the plate that faces the wall 60 to accommodate the head of the molly fastener 34 so that the remainder of plate 20b lies flush against the exposed surface 62 of the wall 60.

According to the second embodiment, the molly fastener 34 is inserted into a hole in the wall 60. The plate 20b is then aligned so that the hole 22b is coaxial with the molly fastener 34. The ledge 24 can be sharp to facilitate penetration of the wall and can be either pressed into the wall manually or with the aid of a hammer. Alternatively, the ledge 24 can be blunt and the wall scored prior to pressing in the blunt ledge. The screw 32 is inserted through a hook 40 and then through the hole 22b into the molly fastener 34. The screw 32 is then turned into the molly fastener 34 to secure hook 40 to the wall. An object (not shown) can be secured to hook 40. It can be appreciated that another object besides hook 40 can be secured to the wall 60.

The plate 20b serves to increase the load carrying abilities of molly fastener 34 and screw 32 by spreading out the load on the wall 60, so that heavier objects can be secured to the wall 60 than could be without plate 20b. It can be appreciated that the present invention can be adapted for a variety of fastening devices such as, screws, nails, molly fasteners, expandable hollow wall fasteners, etc.

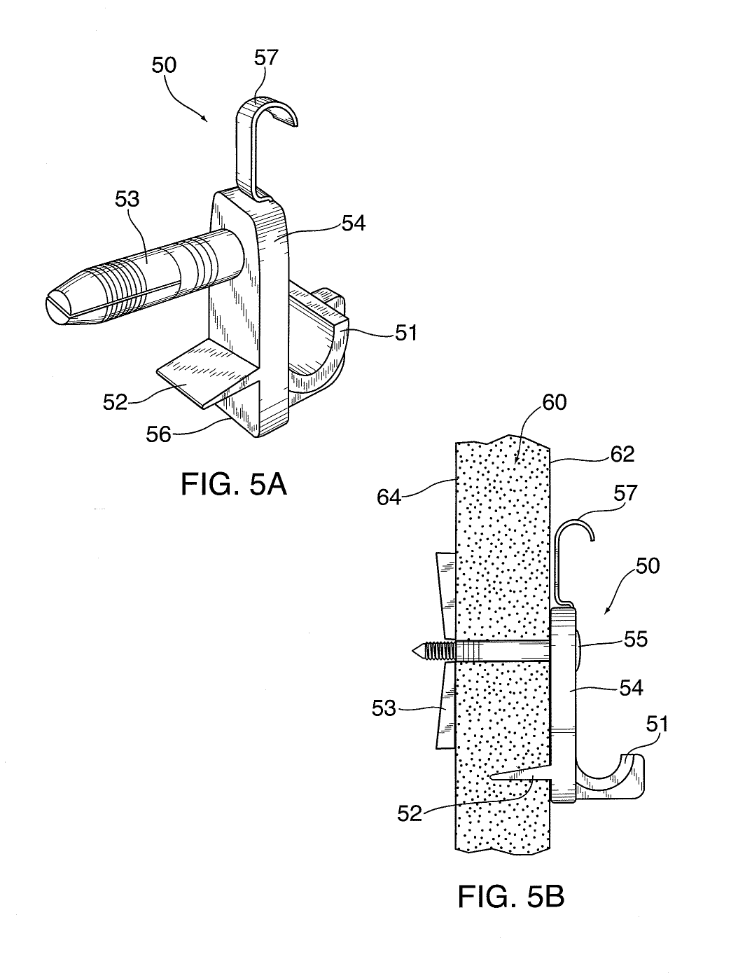

Alternate embodiments of the fastening assemblies of present invention are shown in FIGS. 5A-11B. As seen in FIG. 5A, a fastening assembly 50 according to a third embodiment of the invention is illustrated. The fastening assembly 50 is a novel improvement to the prior art fasteners, such as the product sold under the trademark RUBBERMAID® FASTSET® Back Clip. The fastening assembly 50 includes a planar plate 54 having a through-bore formed therein and having a hook 51 formed on the front of the planar plate 54. Preferably, the fastening assembly 50 is made of a plastic material, however, it can be appreciated that other suitable materials can be utilized.

The fastening assembly 50 also includes a conventional molly fastener 53 formed on the back side of the planar plate 54 in alignment with the through-bore. Fastening assembly 50 also includes a ledge 52 extending outwardly from planar plate 54. Ledge 52 is spaced apart from the bottom edge 56 of the planar plate 54. However, it can be appreciated that the location of the ledge can be varied such as located at the bottom edge 56 (not shown). As can be seen in FIGS. 5A and 5B, the ledge 52 has a flat bottom surface and angled top surface.

In FIG. 5B, the fastening assembly 50 is shown in conjunction with a screw 55 mounted on a wall 60, shown in cross section. Particularly, to install the fastening assembly 50, the molly fastener 53 is inserted into a hole formed in wall 60 and the ledge 52 is inserted through the exposed surface 62 of the wall 60 so that the planar plate 54 lies flush against the exposed side 62 of the wall. Preferably, ledge 52 extends approximately ¾ of the width of the wall. A screw 55 is screwed into the through-bore formed in the center of the molly fastener 53, and in turn, secures the fastening assembly 50 to the wall 60. The ledge 52 increases the load carrying capabilities of fastener 50, as compared to without it. An object (not shown) can then be affixed to the hook 51. Optionally, cover element 57 can be folded down and into a slit (not shown) formed on planar plate 54 to cover the screw head.

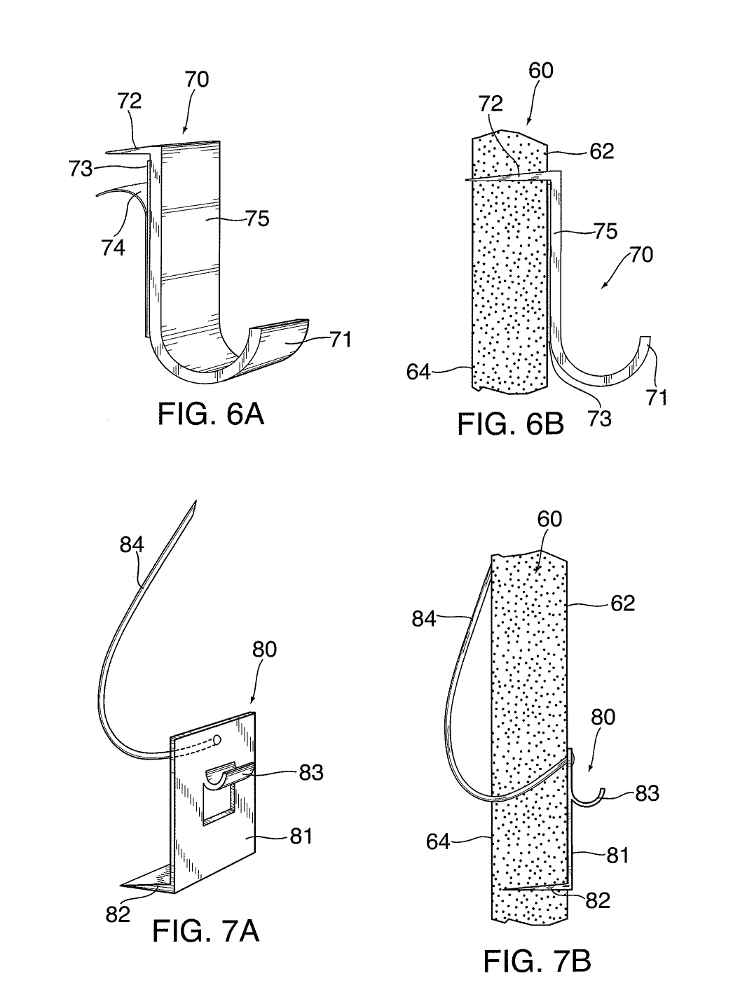

A fastening assembly 70 according to the fourth embodiment is illustrated, in FIGS. 6A and 6B. Fastening assembly 70 is a novel improvement to the prior art fasteners such as the product sold under the trademark 3M COMMAND BRAND™ Damage-Free Hanging hooks. The fastening assembly 70 includes a planar portion 75 with a ledge 72 projecting perpendicular therefrom on the top edge thereof. However, the ledge 72 can be spaced apart from the top edge of the planar portion 75. A hook 71 is formed on the front of the planar portion 75. Preferably, the fastening assembly 70 is made of a plastic material, however, it can be appreciated that other suitable materials can be utilized. The fastener also includes an adhesive layer 73 which is applied to the back side of the planar portion 75. A release strip or ply 74 is secured over the adhesive layer 73. Before installation the release strip 74 is peeled off to expose the adhesive layer 73.

In FIG. 6B, the fastening assembly 70 is shown mounted on a wall 60, shown in cross-section. The ledge 72 is pressed into the wall 60 so that the planar portion 75 lies flush against the wall. The fastener 70 is affixed to the wall 60 via the adhesive layer 73. The ledge 72 serves to increase the overall load carrying ability of fastener 70. Although it is preferable that the ledge 62 extend approximately ¾ of the width of wall 60, it can extend completely through the wall 60 as seen in FIG. 6B. An object (not shown) can then be secured to the hook 71.

In regard to the embodiment of the fastening assembly 80 shown in FIGS. 7A and 7B, it represents a novel improvement to prior art fasteners such as, the product sold under the trademark HILLMAN NOSTUD™ DRYWALL 200 picture hanger. The fastening assembly 80 includes a planar plate 81 having a hook 83 formed on the front thereof by curving upwardly a portion cut-out from the plate 81. Preferably, the fastening assembly 80 is made of a metal material, however, other materials can be utilized. Along the bottom edge of the planar plate 81 is an outwardly-extending ledge 82. A generally C-shaped curved, wire hook 84 is also secured to the back side of the planar plate 81.

In order to secure the fastener 80 to wall 60, as shown in FIG. 7B, the wire hook 84 is inserted through the wall 60 and positioned so that the top end of wire 84 contacts the concealed surface 64 of the wall 60. The ledge 82 is then inserted into the wall 60 so that the planar plate 81 lies flush against exposed surface 62 of the wall 60. An object (not shown) can then be affixed to the hook 83.

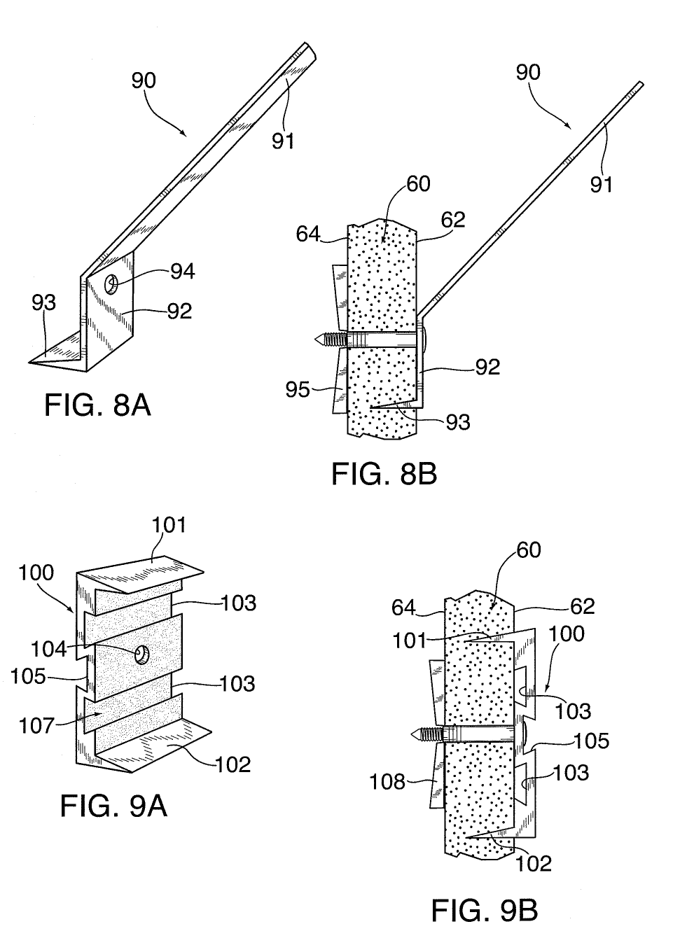

Turning now to FIGS. 8A and 8B, a fastening assembly 90 according to another embodiment of the invention is shown. This embodiment is a novel improvement to the prior art fasteners such as the product sold under the trademark RUBBERMAID® SUPPORT BRACE. Fastening assembly 90 includes angled bracket portions 91 and 92. Fastening assembly 90 is preferably made of metal, however, other suitable materials can be utilized. A through-bore 94 is formed through bracket portion 92. On the bottom edge of bracket portion 92 is an outwardly-extending ledge 93. FIG. 8B shows the fastening assembly 90 in conjunction with a molly fastener 95 mounted on a wall 60, shown in cross-section. To install the fastener, the ledge 93 is inserted into the wall 60 so that bracket portion 92 lies flush against the exposed surface 62 of the wall 60. A screw or other fastener, here molly fastener 95 can then be inserted through through-bore 94 and into a hole formed in wall 60 in order to secure the fastening assembly 90 in place.

In regard to the seventh embodiment of the fastener 100 shown in FIGS. 9A and 9B, it includes two ledges, particularly ledge 101 located on the top edge and ledge 102 located on the bottom edge of the fastening assembly 100. The two ledges 101 and 102 are angled in the same direction and both have flat bottom surfaces and angled top surfaces. Fastening assembly 100 also includes two cut-out notch portions 103 formed on the backside of the fastening assembly. In the center of the fastener 100 is a through-bore 104. The fastener 100 includes a cut-out notch portion 105 on the front thereof for securing an object (not shown) thereto. Preferably, fastening assembly 100 is made of a metal material, however, other suitable materials can be utilized.

As seen in FIG. 9B, the fastening assembly 100 is shown mounted on a wall 60, shown in cross-section. The ledges 101 and 102 are inserted into the wall 60. As seen in FIG. 9A, the fastener 100 optionally includes an adhesive layer 107 formed on the back of the fastener so that when the ledges 101 and 102 are inserted into the wall 60 it forms a mechanical lock to secure the fastener 100 to the wall. Optionally, a fastener, in this case molly fastener 108 can be inserted into through-bore 104 and, in turn, into wall 60 to further secure the fastening assembly 100 to the wall 60, but other fasteners such as a nail or screw can be utilized.

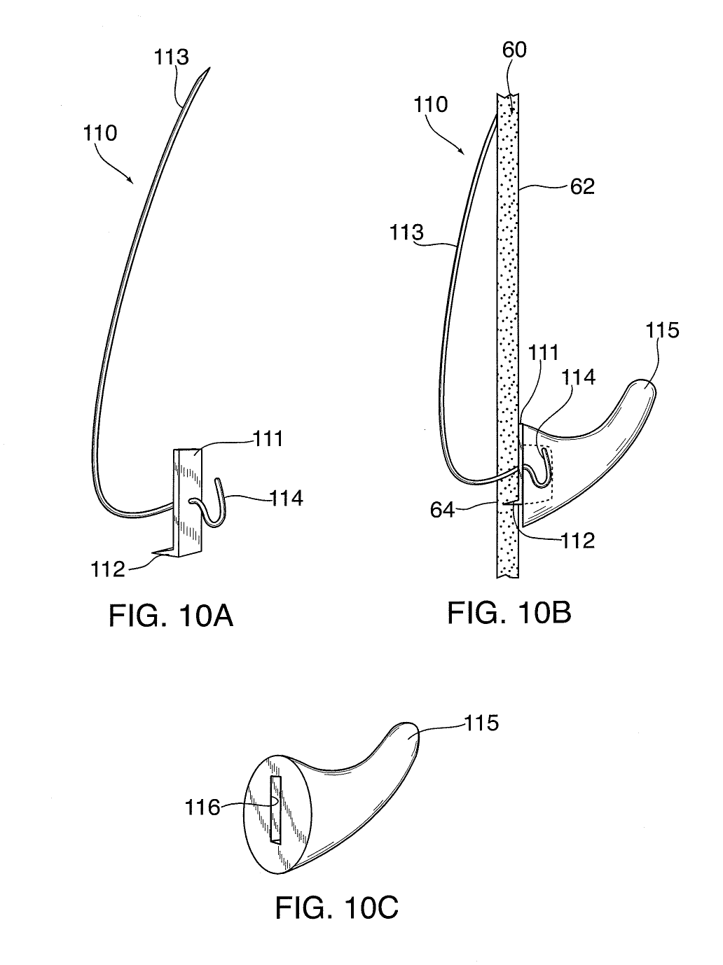

As seen in FIGS. 10A through 10C, an eighth embodiment of the fastening assembly 110 according to the present invention is illustrated. Fastening assembly 100 is an improvement to prior art fasteners, such as, the product sold under the trademark MONKEY MATES™ BY MONKEY HOOK® UTILITY HOOKS. Fastening assembly 110 is preferably made of metal, however, other suitable materials can be utilized. Fastening assembly 110 includes a planar plate 111 having a ledge 112 extending perpendicular therefrom on the bottom edge thereof. A generally C-shaped wire support 113 is affixed to the back side of the planar plate 111. The front end of the wire support 113 includes a hook 114.

FIG. 10B shows the fastening assembly 110 mounted on a wall 60, shown in cross-section. To install the fastening assembly 110, the wire support 113 is inserted through the wall 60 and positioned so that the top end thereof touches the concealed side 64 of the wall 60 to provide leverage. The ledge 112 is inserted through the exposed side 62 of the wall 60 so that it extends into wall 60, preferably approximately ¾ of the width of the wall, but can be inserted to other depths or through the wall 60. An optional decorative hook 115 can be placed over the hook 114, via a slot 116 formed in the decorative hook 115 (seen best in FIG. 10c). An object (not shown) can then be secured to hook 114 or decorative hook 115.

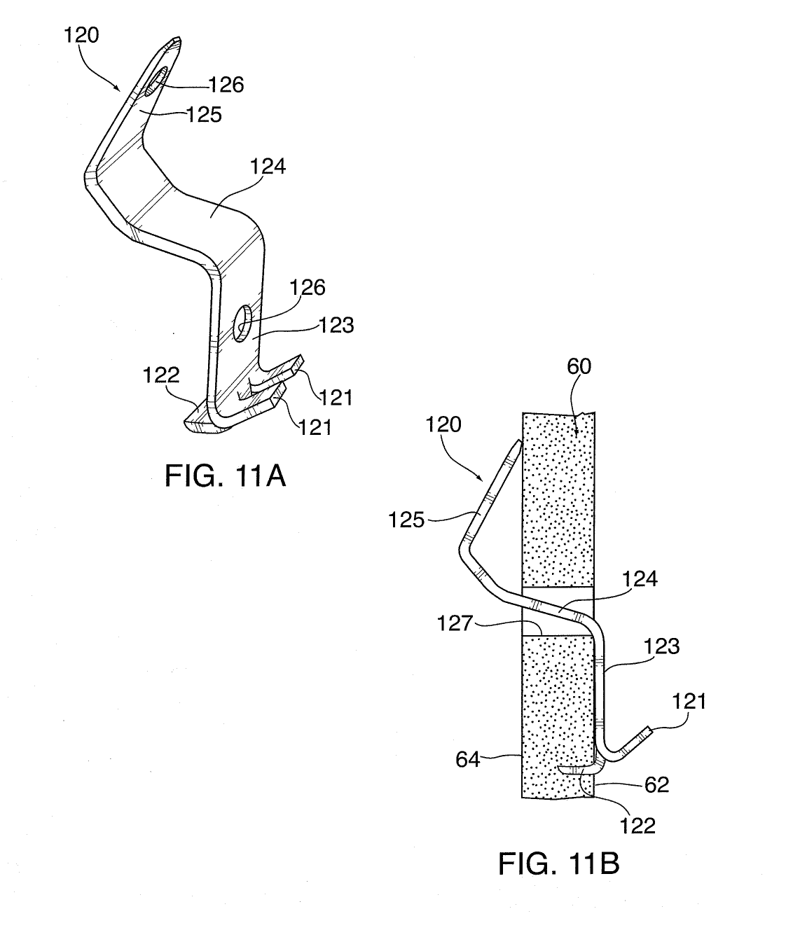

A ninth embodiment of a fastening assembly 120 is shown in FIGS. 11A and 11B. Preferably, the fastening assembly 120 is made of a metal material, however, other suitable materials can be utilized. The fastening assembly 120 includes a flat center portion 124, and two end portions 125 and 123 which extend generally perpendicular therefrom in opposite directions so that fastener 120 assumes an overall generally S-shape. The fastener 120 optionally includes through-bores 126. On the front of the fastening assembly 120 are two hooks 121 and on the back thereof is a ledge 122. The two hooks 121 allow for multiple objects to be secured to the fastening assembly 120, although any other number of hooks could be utilized.

FIG. 11B shows fastener 120 secured to a wall 60, shown in cross-section. To install fastener 120 a slot or hole 127 is formed through the wall 60. The upwardly extending portion 125 of the fasteners 120 is inserted through the hole 127, so that it curves and rests against the concealed side 64 of the wall 60. Ledge 122 is then inserted into the front side of the wall 62 so that end portion 123 lies flush against the exposed side 62 of the wall 60. An object (not shown) can be secured to either or both of the hooks 121. Optionally, a nail or screw can be inserted into through-bore 127 to further secure fastener 120 to wall 60.

As can be appreciated, the construction of all of the embodiments of the present invention allows for the fastening assemblies to support particularly heavy objects to a wall, due to the L-shaped member having a ledge projecting outwardly therefrom, which is at least partially received in the wall. The support of such heavy loads is not presently accomplishable with the prior art fasteners described. It can be appreciated that such L-shaped configuration and ledge of the present invention can be adapted to other types of fasteners to increase their overall load carrying capabilities.

As can be appreciated, the means for fastening an object to the fastening assemblies can vary. Particularly, the means for fastening can serve the dual function of both fastening the member to the wall and for securing an object to the wall, such as the nail 30, shown in FIG. 1. Alternatively, the fastening assemblies can further include means for supporting an object on the wall, such as hook 40, shown in FIG. 3. As another alternative, the planar member may further include integral means for fastening the object to the wall, such as, for example hook 51 in FIG. 5A, hook 71 in FIG. 6A, or hook 83 in FIG. 7A. Moreover, the number of hooks or means for fastening the object can vary.

There have been described and illustrated herein several embodiments of a fastener support and methods of installing it. While particular embodiments of the invention have been described, it is not intended that the invention be limited thereto, as it is intended that the invention be as broad in scope as the art will allow and that the specification be read likewise. Thus, while the fastener supports have been illustrated as generally rectangular, they could be configured as triangles or other polygons or even be circular or oval. Furthermore, although the ledges are illustrated as having a pointed configuration, it can have a blunt edge or a square shaped edge and the wall scored prior to the insertion into the wall.

Additionally, the location and number of ledges utilized can vary. While it is preferable that the ledges extend approximately ¾ of the width of the wall, the length of the ledge can vary so that it extends to other depths into the wall or even through the wall so that the end thereof projects outwardly from the concealed side of the wall. Moreover, although the fasteners are primarily intended for use with gypsum wall board and the like, it may be possible to adapt the fastening assemblies to use with walls made of other materials. It will therefore be appreciated by those skilled in the art that yet other modifications could be made to the provided invention without deviating from its spirit and scope as claimed.

What is claimed is:

1. A fastener assembly for mounting an object on a wall, comprising:
a substantially planar member having at least one ledge extending substantially perpendicular therefrom, said member being configured to permit at least a portion of said planar member to lie flush against the wall with said at least one ledge inserted at least partially through the wall; and
means for fastening said member to the wall.

2. The fastener assembly according to claim 1, wherein:
said at least one ledge has a length which is less than a thickness of the wall.

3. The fastener assembly according to claim 1, wherein:
said at least one ledge has a length which is equal to or greater than the thickness of the wall.

4. The fastener assembly according to claim 1, wherein:
said member has a through-bore.

5. The fastener assembly according to claim 4, wherein:
said through-bore has an axis which forms an acute angle relative to said member.

6. The fastener assembly according to claim 4, wherein:
said through-bore has an axis which is substantially perpendicular to said member.

7. The fastener assembly according to claim 4, wherein:
said means for fastening said member to the wall comprises a nail which is receivable within said through-bore.

8. The fastener assembly according to claim 6, wherein:
said means for fastening said member to the wall comprises a molly fastener and a screw receivable within said through-bore.

9. The fastener assembly according to claim 1, wherein:
said member has a front side and a back side and said means for fastening said member to the wall comprises an adhesive layer disposed on said back side of said member.

10. The fastener assembly according to claim 1, wherein:
said member has a front side and a back side and said means for fastening comprises a curved, support member having a tip projecting outwardly and rearwardly from the back side of said member which, when fully mounted, projects through the wall with its tip resiliently contacting a concealed surface of the wall.

11. The fastener assembly according to claim 1, wherein:
said member defines a bottom edge; and
said at least one ledge is located on said bottom edge of said member.

12. The fastener assembly according to claim 1, wherein:
said member defines a top edge; and
said at least one ledge is located on said top edge of said member.

13. The fastener assembly according to claim 1, wherein:
said member defines a top edge and a bottom edge and said at least one ledge is disposed between said top and bottom edges.

14. The fastener assembly according to claim 1, further comprising:
means for supporting the object on the wall.

15. The fastener assembly according to claim 1, wherein:
said planar member has means for supporting the object on the wall.

16. The fastener assembly according to claim 1, wherein:
said means for fastening also serves to support the object on the wall.

17. A method of installing a fastener assembly for mounting an object on a wall, comprising the steps of:
providing a fastener assembly comprising a substantially planar member having at least one ledge extending substantially perpendicular therefrom, said member being configured to permit at least a portion of said planar member to lie flush against the wall with said at least one ledge inserted at least partially through the wall and means for fastening said member to the wall;
inserting said at least one ledge at least partially into the wall so that at least a portion of said member lies flush against the wall; and
securing said member to the wall via said means for fastening.

18. The method according to claim 17, wherein:
said at least one ledge has an edge to permit it to pierce the wall during said inserting step.

19. The method according to claim 17, wherein:
said fastening assembly further comprises means for supporting the object.

20. The method according to claim 19, further comprising the step of:
securing the object to said means for supporting the object.
